(19) United States
(12) Patent Application Publication
(10) Pub. No.: US 2025/0368787 A1
(43) Pub. Date: Dec. 4, 2025

(54) POLYLACTIDE-PEROXIDE MASTERBATCHES AND BRANCHING PROCESS

(71) Applicant: NatureWorks LLC, Plymouth, MN (US)

(72) Inventors: Adegbola Adenusi, Duluth, MN (US); Marc Flodquist, St. Anthony, MN (US); Nemat Hossieny, Medina, MN (US); Jed Richard Randall, Minneapolis, MN (US)

(21) Appl. No.: 19/222,482

(22) Filed: May 29, 2025

Related U.S. Application Data
(60) Provisional application No. 63/654,218, filed on May 31, 2024.

(51) Int. Cl. C08J 3/22; C08J 3/24; C08K 5/14

(52) U.S. Cl. CPC C08J 3/22; C08J 3/247; C08K 5/14; C08J 2367/04

(57) ABSTRACT

Solidified polylactide-peroxide masterbatches contain at least 50% of a linear amorphous grade polylactide resin and 1 to 30 parts, per 100 parts by weight of the polylactide, of a peroxide having a half-life of at least 50 seconds at 180° C. The masterbatches are made by combining the polylactide resin and peroxide at a temperature of 80 to 170° C. and then cooling the resulting mixture. The masterbatch is useful for preparing branched and/or crosslinked polylactides.

### RELATED APPLICATIONS

This application claims the benefit of U.S. Provisional Application No. 63/654,218, filed May 31, 2024, the content of which is herein incorporated by reference in its entirety.

This invention relates to masterbatches of polylactide and peroxides, and methods for branching polymers using those masterbatches.

PLA is a linear thermoplastic that is converted into a variety of end-use products. It is often desirable to introduce branching in PLA and other linear thermoplastics to widen processing windows and increase melt strength.

Peroxides are known branching agents for various polymers, including polylactide resins (PLA). See, e.g., U.S. Pat. Nos. 5,594,095 and 5,798,435. This branching reaction is difficult to control and produces a substantial quantity of crosslinked gels. These gels create various problems when the polylactide is melt-processed. They form defects in the resulting parts, clog orifices in the production equipment and deposit onto equipment surfaces. Certain cyclic peroxides have been evaluated for branching polylactide resins, as shown, for example, in U.S. Pat. No. 8,334,348, but these cyclic peroxides are very inefficient branching agents. Only small increases in weight average molecular weight (M_{w}) are obtained. Little gelling is seen only because of the poor efficiency of the branching reaction. Better results have been obtained by using the cyclic peroxide in combination with a polyene compound such as triallyl isocyanurate. See, e.g., Yang et al. in “Thermal and Mechanical Properties of Chemical Crosslinked Polylactide (PLA)”, Polymer Testing 27 (2008) 957-963, describe the combined use of triallyl isocyanurate (TAIC) and dicumyl peroxide to crosslink polylactide. This produces a “highly crosslinked structure” associated with an increased brittleness that the authors identified as a “problem needing to be overcome”. WO 2019/152264A describes hyperbranched polylactide compositions made by melt-processing a linear PLA with certain cyclic peroxides and a polyene compound, under conditions that cause the peroxide to decompose. Those hyperbranched compositions can be let down into more PLA to produce a less-branched composition. No further branching occurs during the let-down process because the peroxide is entirely consumed in the prior branching step.

U.S. Pat. No. 9,527,967 describes masterbatches made by impregnating a porous PLA with a liquid peroxide. This is performed at low temperature to produce porous resin particles that contain liquid peroxide trapped within its pores. The PLA resin is not branched during the impregnation step.

The invention is in one aspect a solidified polylactide-peroxide masterbatch comprising a thermoplastic resin phase comprising at least 50% by weight of a linear amorphous grade polylactide resin based on the weight of the thermoplastic resin phase and 1 to 30 parts by weight per 100 parts by weight of the thermoplastic resin phase of a peroxide, the peroxide having a half-life of at least 50 seconds at 180° C. dissolved or dispersed in the thermoplastic resin phase.

In a second aspect, this invention is a method for making a solidified polylactide-peroxide masterbatch, comprising the steps of

i) combining a) one or more thermoplastic resins, the thermoplastic resins comprising at least 50% by weight of a starting linear amorphous grade polylactide resin with b) 1 to 30 parts by weight, per 100 parts by weight of the starting amorphous grade PLA resin, of a peroxide, the peroxide having a half-life of at least 50 seconds at 180° C. and mixing the starting linear amorphous grade polylactide and the peroxide at a temperature of 80 to 170° C. to produce a solution or dispersion of the peroxide in the thermoplastic resins, and

ii) cooling the solution or dispersion to a temperature of at most 40° C. to produce the solidified polylactide-peroxide masterbatch.

The invention is also a method for branching and/or crosslinking polylactide, comprising the steps of

I. combining a solidified polylactide-peroxide masterbatch of the first aspect of the invention with additional linear polylactide resin to produce a reactive mixture containing 0.01 to 0.5 weight percent of the peroxide and polylactides comprising the starting linear amorphous grade polylactide resin and the additional linear polylactide resin; and

II. heating the reactive mixture obtained in step I to a temperature of at least 180° C. to heat-soften the polylactides, decompose the peroxide and branch and/or crosslink at least a portion of the polylactides.

The various aspects of the invention provide an effective and inexpensive solution to the problem of branching and/or crosslinking polylactides with peroxides. The masterbatch of the invention is an effective carrier of active peroxides. The selection of amorphous grades of polylactides and low temperatures to produce the masterbatch permits the peroxide to be distributed uniformly and in high concentrations into a resin phase, with little or no decomposition of the peroxide during the masterbatch process. The high concentration of active peroxide in the masterbatch allows the masterbatch to be let down into very large relative amounts of additional linear polylactide resin during a subsequent branching process. This allows the masterbatch and the peroxide it contains to be evenly distributed into the additional linear polylactide resin, which in turn facilitates branching and/or crosslinking with minimal gel formation. A particular advantage is the branching and/or crosslinking step becomes highly controllable; in particular, a branched product can be produced with little or no gel formation or other crosslinking, when desired. Another advantage is that the masterbatch can be let down even into crystallizable polylactide resins and doing so has minimal if any effect on the crystallization of the final, branched product due to the small amounts of masterbatch that are needed to obtain the good branching and/or crosslinking.

The masterbatch includes a thermoplastic resin phase. At least 50% by weight of the thermoplastic resin phase is a linear amorphous grade polylactide resin. A “polylactide resin” is a polymer of lactide having repeating units of the structure —OC(═O)CH CH₃)— (“lactic units”). The polylactide resin contains at least 90% by weight of such lactic units, and preferably contains at least 95% or at least 98% by weight of lactic units.

The linear amorphous grade polylactide resin may contain minor amounts, such as up to 10%, preferably up to 5% and more preferably up to 2% by weight, of residues of an initiator compound and/or repeating units derived from other monomers that are copolymerizable with lactide. Suitable such initiators include difunctional compounds such as water, alcohols, glycol ethers, and polyhydroxy compounds of various types (such as ethylene glycol, propylene glycol, polyethylene glycol, polypropylene glycol, and the like). Examples of copolymerizable monomers include glycolic acid, 2-hydroxybutyric acid and other α-hydroxyacids which can condense with lactic acid and generate cyclic diester impurities in lactide; alkylene oxides (including ethylene oxide, propylene oxide, butylene oxide, tetramethylene oxide, and the like); cyclic lactones; or cyclic carbonates. The polylactide resin(s) most preferably is essentially devoid of such repeating units derived from other monomers.

By “linear” it is meant that the amorphous grade polylactide resin contains no branches that have 6 or more carbon atoms. Side-chains or pendant groups having fewer than 6 carbon atoms (including pendant methyl groups on each lactic unit of the polylactide resin) are not considered as “branches” for purposes of this invention.

By an “amorphous grade”, it is meant the polylactide is one that contains no more than 5 J/g of crystallites after being subjected to the following protocol: The sample is previously heated to at least 220° C. to melt any crystallites and then quenched by rapidly cooling to room temperature (23±3° C.). The quenched sample is then heated at 110° C. for one hour and again quenched by cooling rapidly to room temperature. Crystallinity then is conveniently measured using differential scanning calorimetry (DSC) methods. The amount of such crystallinity is expressed herein in terms of J/g, i.e., the enthalpy of melting, in Joules, of the polylactide crystals in the sample, divided by the weight in grams of polylactide(s) in the sample. A convenient test protocol for making DSC measurements is to heat a 2-10 milligram sample from 25° C. to 225° C. at 20° C./minute under air, on a Mettler Toledo DSC 3+ calorimeter running STARe V.16 software, or equivalent apparatus.

The amorphous grade polylactide resin may have a glass transition temperature of up to 80° C., 40 to 70° C., as measured by differential scanning calorimetry per ASTM D-1356-03.

Lactic units contain a chiral carbon atom and therefore exist in two enantiomeric forms, the “L” (or “S”) enantiomer and the “D” (or “R”) enantiomer. Linear amorphous grade polylactide resins are generally characterized in that least 10% (by weight or, equivalently, by mole) of the lactic units in the polylactide resin are L-lactic units and at least 10% are D-lactic units. At least 12%, at least 15%, at least 20%, at least 25% or at least 40% of the lactic units in the linear amorphous grade polylactide resin may be L-lactic units and at least 12%, at least 15%, at least 20%, at least 25% or at least 40% of the lactic units in the amorphous grade polylactide resin may be D-lactic units. The L- and D-lactic units are incorporated by polymerization of meso-lactide and/or a mixture of two or more of L-lactide, D-lactide and meso-lactide, the ratios of such a mixture being selected to provide L- and D-lactic units in the proportions mentioned above. Specific examples of linear amorphous grade polylactide resins are random copolymers of L-lactide and meso-lactide (and optionally small amounts such as up to 2 mole-% of D-lactide, and homopolymers of meso-lactide. Such random copolymers in some embodiments may contain greater than 80% and at most 90% L-lactic units and correspondingly less than 20% and at least 10% D-lactic units or greater than 80% and at most 90% D-lactic units and correspondingly less than 20% and at least 10% L-lactic units. In other embodiments the random copolymer contains 20 to 80% L-lactic units and correspondingly 80 to 20% D-lactic units, based on the total amount of lactic units in the random copolymer. In still other embodiments the random copolymer contains 40 to 60% L-lactic units and correspondingly 60 to 40% D-lactic units, based on the weight of lactic units in the random copolymer.

The amorphous grade polylactide resin may have a relative viscosity of 2.0 to 4.5. In particular embodiments, the relative viscosity is at least 2.5 or at least 2.75 and is up to 4, up to 3.75 or up to 3.5. Relative viscosity is the ratio of the viscosity of a 1% wt/vol solution of the polylactide resin in chloroform to that of a chloroform standard, as measured using a capillary viscometer at 30° C.

The linear polylactide resin(s) may have hydroxyl end groups, carboxyl end groups or both hydroxyl and carboxyl end groups. In some embodiments, at least a portion of the linear polylactide resin molecules have one hydroxyl and one carboxyl end group. In some embodiments, at least a portion of the linear polylactide resin molecules have two carboxyl end groups and no hydroxyl end groups.

The linear amorphous grade polylactide resins(s) can be prepared by polymerizing lactide in the presence of a polymerization catalyst as described in, for example, U.S. Pat. Nos. 5,247,059, 5,258,488 and 5,274,073. This preferred polymerization process typically includes a devolatilization step during which the free lactide content of the polymer is reduced, preferably to less than 1% by weight, more preferably less than 0.5% by weight or less than 0.3% by weight, and especially less than 0.2% by weight. The polymerization catalyst is preferably deactivated or removed from the linear amorphous grade polylactide resin.

The linear amorphous grade polylactide resin may include virgin materials and/or recycled post-industrial or post-consumer polylactide resin.

The thermoplastic resin phase may include up to 50% by weight of one or more other thermoplastic polymers, which are not polylactides. Such other thermoplastic polymer(s) should have a glass transition temperature of at most 150° C., preferably at most 100° C. or at most 80° C. and, if semi-crystalline, also should have a crystalline melting temperature of at most 150° C., preferably at most 100° C. or at most 80° C. In certain embodiments, the thermoplastic resin phase includes 0 to 50 weight-%, 1 to 50 weight-%, 1 to 25 weight-% or 1 to 10 weight-% of such one or more other thermoplastic polymers.

The peroxide is one having a half-life of at least 50 seconds at 180° C. The peroxide preferably has a half-life of at least 60 seconds or at least 80 seconds, more preferably 80 to 1000 seconds, at 180° C. Peroxide half-life is conveniently measured in a 0.1M monochlorobenzene solution by DSC-TAM.

The peroxide may be acyclic or cyclic. An example of an acyclic peroxide is di-t-amyl peroxide (such as Luperox® DTA, available from Arkema USA), which has a half-life of about 86 seconds at 180° C., and 2,5-Dimethyl-2,5-di (tert-butylperoxy) hexane, which is available as Trigonox® 101 from Nouryon. The cyclic peroxides are characterized as having at least one cyclic structure in which one or more peroxide (—O—O—) linkages form part of a ring. Among the suitable cyclic peroxides (component iii) are cyclic ketones and 1,2,4-trioxepanes as described, for example, in U.S. Pat. No. 8,334,348.

Among the useful cyclic ketones are those having any of the structures I-III:

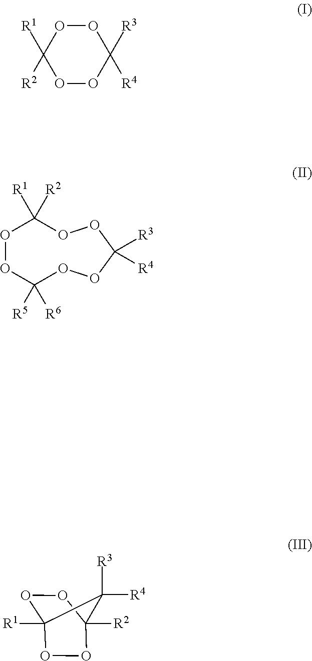

wherein each of R¹-R⁶ are independently selected from the group consisting of hydrogen, C₁₋₂₀ alkyl, C₃₋₂₀ cycloalkyl, C₆₋₂₀ aryl, C₇₋₂₀ aralkyl and C₇₋₂₀ alkaryl, any of which may optionally be substituted with one or more groups selected from hydroxyl, alkoxy, linear or branched alkyl, aryloxy, ester, carboxy, nitrile and amido. The cyclic ketone peroxides preferably contain only carbon, hydrogen and oxygen atoms.

Suitable 1,2,4-trioxepanes (1,2,4-cycloheptanes) include those having the structure:

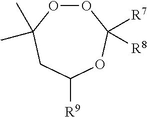

wherein R⁷, R⁸ and R⁹ are independently hydrogen or hydrocarbyl that may be substituted with one or more groups selected from hydroxyl, alkoxy, linear or branched alkyl, aryloxy, ester, carboxy, nitrile and amido and provided that any two of R⁷, R⁸ and R⁹ may together form a divalent moiety that forms a ring structure with the intervening atoms of the trioxepane ring.

In some embodiments, R⁷ and R⁹ each independently may be C₁₋₆ alkyl with methyl and ethyl being preferred. R⁸ in some embodiments may be hydrogen, methyl, ethyl, isopropyl, isobutyl, t-butyl, amyl, iso-amyl, cyclohexyl, phenyl, CH₃C(O)CH₂—, C₂H₅OC (O) CH₂—, HOC(CH₃)₂CH₂— or

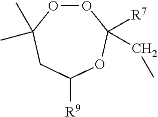

In other embodiments R⁷ and R⁸ together with the carbon atom to which they are bonded form a cyclohexane ring.

Specific cyclic peroxides include 3,6,9-triethyl-3,6,9-trimethyl-1,4,7-triperoxononane, which is available as Trigonox® 301 from Nouryon 3,3,5,7,7-pentamethyl-1,2,4-trioxepane, which is available as Trigonox® 311 from Nouryon and 3-ethyl-3,5,7,7-tetramethyl-1,2,4-trioxepane which is available as MEK-TP from Nouryon.

The masterbatch contains 1 to 30 parts by weight of the peroxide per 100 parts by weight of the linear amorphous grade polylactide resin. In specific embodiments, the masterbatch contains at least 2, at least 4 or at least 5 parts of the peroxide and up to 25, up to 15 or up to 10 parts of the peroxide, on the same basis.

The masterbatch may contain other components, but these are all optional and can be omitted. Examples of such components include extrusion aids such as lubricants, impact modifiers, rheology modifiers, colorants, particular fillers and the like.

The masterbatch is made by combining the thermoplastic resin(s), including the linear amorphous grade polylactide resin, and the peroxide and mixing them at a temperature of 80° C. to 170° C. The thermoplastic resin(s) and peroxide may be heated separately to the mixing temperature or heated together to the mixing temperature. Mixing can be performed in any convenient apparatus that provides temperature control and agitation. A particularly suitable device is a single- or twin-screw extruder. Other devices such as a Haake mixer or Brabender mixer are also suitable. In a particular process, the thermoplastic resin(s) are heated to the aforementioned temperature to heat-soften the resin(s), the peroxide is introduced into the apparatus and in contact with the heat-softened resin(s) and mixed in to produce a solution or dispersion of the peroxide in the heat-softened resin(s).

The peroxide may be added in the form of a liquid or solid. The peroxide may be dissolved or dispersed in a solvent or diluent. Peroxides added in solid form preferably are in the form of a particulate to facilitate uniform distribution.

The temperature preferably is above the glass transition temperature of the linear amorphous polylactide resin. A preferred upper temperature is, in general, 160° C. or 155° C. In embodiments in which the linear amorphous polylactide resin contains 20 to 80% L-lactic units and correspondingly 80 to 20% D-lactic units, based on the total amount of lactic units in the resin, a preferred temperature is 80 to 130° C., especially 80 to 120° or 90 to 110° C.

The mixing time may be, for example, from 5 seconds to 10 minutes or more. Shorter mixing times are preferred to minimize decomposition of the peroxide at the mixing temperature. An advantage of this invention is that little peroxide decomposition takes during the mixing step, due to the relatively low mixing temperatures used.

The masterbatch preferably is produced in the absence of blowing agents (including physical and chemical blowing agents) that produce a blowing gas under the conditions at which the masterbatch is produced. Similarly, it is preferred to employ mixing conditions that avoid entraining air or other gas into the mixture of thermoplastic resin(s) and peroxide. The polylactide-peroxide masterbatch preferably has a void volume of no greater than 2%, especially no greater than 1%.

The solution or dispersion produced in the mixing step is then cooled to a temperature of 40° C. or lower. This solidifies the thermoplastic resin(s) and produces the polylactide-peroxide masterbatch. In a preferred process, the solution or dispersion is passed through a die of a single- or twin-screw extruder into a cooling bath or into ambient temperature air, where it cools to form solidified strands that can be subsequently chopped into pellets. For purpose of this invention, the masterbatch is considered as “solidified” if at a temperature below the grass transition temperature of the linear amorphous grad polylactide resin.

A small amount of branching may take place during the masterbatch process. The polylactide in the masterbatch may have a branching number Bn of up to 2.4, preferably up to 2.3 or up to 2.2, as determined by the method described in WO 2019/152264A and in the examples below.

The polylactide-peroxide masterbatch preferably is substantially non-porous, having a bulk density of at least 95%, at least 98% or at least 99% of that of the polylactide resin(s) by itself.

The polylactide-peroxide masterbatch is useful for branching or even crosslinking polylactide. When used to branch polylactide, the masterbatch is an effective carrier for the peroxide, allowing the peroxide to be dosed accurately and distributed more evenly into an additional polylactide resin. This allows for controllable and reproducible yet effective branching, with minimal gel formation.

In branching polylactide, the polylactide-peroxide masterbatch is combined with additional linear polylactide resin to produce a reactive mixture. The reactive mixture, therefore, comprises polylactide resins comprising both the starting linear amorphous grade polylactide resin and the additional linear polylactide resin. The relative amounts of polylactide-peroxide masterbatch and additional linear polylactide resin are selected so the reactive mixture contains 0.001 to 0.5 weight percent of the peroxide. A preferred amount is at least 0.005 weight percent or at least 0.01 weight percent, and up to 0.2 weight percent or up to 0.1 weight percent. The weight ratio of masterbatch to additional polylactide resin may be, for example, 0.01:100 to 5:100, especially 0.01:100 to 1:100.

The additional linear polylactide resin may be an amorphous grade polylactide resin as described before. In other embodiments, the additional linear polylactide resin is a semi-crystalline grade, i.e., one that contains greater than 5 J/g, preferably at least 20 J/g, of crystallites after being heated at 110° C. in air for one hour when evaluated according to the protocol described before. Semi-crystalline grades polylactide resins are generally characterized in that greater than 90%, preferably at least 92% or at least 95% (by weight or, equivalently, by mole) of the lactic units in the polylactide resin are L-lactic units or greater than 90%, preferably at least 92% or at least 95% (by weight or, equivalently, by mole) of the lactic units in the polylactide resin are D-lactic units. A semi-crystalline additional polylactide resin may be a random copolymer of L-lactide and meso-lactide (and optionally small amounts such as up to 2 mole % of D-lactide), or a random copolymer of D-lactide and meso-lactide (and optionally small amounts such as up to 2 mole % of L-lactide).

In other respects, the additional polylactide resin (whether an amorphous or semi-crystalline grade) preferably is as described with regard to the linear amorphous grade polylactide resin used in making the masterbatch.

The reactive mixture is heated to a temperature of at least 180° C. The temperature is preferably at least 190° C. and is preferably up to 250° C. or up to 235° C. to avoid excessive thermal degradation of the polylactide resins. The polylactide-peroxide masterbatch and additional polylactide resin preferably are combined before or at the same time the cyclic peroxide compound is brought to a temperature at which it has a half-life of 5 minutes or less. Thus, for example, a dry blend of the additional linear polylactide resin and the polylactide-peroxide masterbatch can be formed, which dry blend is then heated to the aforementioned temperatures and perform the branching reaction. Alternatively, the additional linear polylactide resin can be heated separately to heat soften it, and the masterbatch in solid form is then combined with the heat softened additional linear polylactide resin to heat it to the reaction temperature, decompose the peroxide and branch the polylactides. For example, the additional linear polylactide resin may be fed through a feed port into an extruder where it is heat-softened and brought to the reaction temperature. The polylactide-peroxide then may be introduced into the extruder via a downstream feed port where it is combined with the heat softened additional polylactide resin and brought to the reaction temperature. Polyene compounds, a preferred additive described more fully below, when used can be added as a solid or liquid together with the additional linear polylactide resin, with the polylactide-peroxide masterbatch, or separately.

The reactive mixture may be maintained at the aforementioned temperature for a period of, for example, 0.2 to 30 minutes or longer, particularly 0.2 to 10 minutes or 0.2 to 2 minutes. The polylactides heat-soften at such temperatures and the peroxide decomposes to produce free radicals that react with the polylactide resins and introduce branching. Either or both of the starting linear amorphous grade polylactide resin and the additional linear polylactide resin may become branched.

The reactive mixture used in the branching reaction may contain various additional ingredients. Among these optional ingredients are one or more other thermoplastic polymers, which are not polylactides, such as are described before: lubricants or other extrusion process aids; fillers, reinforcing agents, impact modifiers, plasticizers, and the like. Branching may be introduced into certain of these optional ingredients, particularly other (non-polylactide) thermoplastic polymers, under the conditions at which the polylactide branching reaction takes place.

A preferred additional ingredient is a polyene compound that contains 2 to 6 vinyl groups per molecule. A “vinyl” group for purposes of this invention is a CHR═CHR group, where each R is independently hydrogen or linear, branched or cyclic alkyl having up to 6 carbon atoms, or phenyl. The vinyl groups preferably are allylic, i.e., part of a larger group having the form —CH₂—CHR═CHR, and/or are enones i.e., part of a larger group having the form —C(O)—CHR═CHR. R is preferably hydrogen in each case.

In some embodiments, the polyene compound(s) each (if more than one) contains 2 to 4 vinyl groups per molecule and in particular embodiments contains 2 or 3 vinyl groups per molecule.

Each polyene compound may have an equivalent weight per vinyl group of up to 500. This equivalent weight may be at least 50, at least 70 or at least 80 and up to 400, up to 300 or up to 250.

Examples of suitable polyene compounds include, for example, various compounds corresponding to esters of acrylic acid and a polyol. These include, for example, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene glycol diacrylate, dipropylene glycol diacrylate, tripropylene glycol diacrylate, cyclohexane dimethanol diacrylate, alkoxylated hexanediol diacrylate, neopentyl glycol diacrylate, propoxylated neopentyl glycol diacrylate, trimethylolpropane triacrylate, ethoxylated trimethylolpropane triacrylate, propoxylated trimethylolpropane triacrylate, glycerine triacrylate, ethyloxylated and/or propoxylated glycerine triacrylate, pentaerythritol di-, tri- or tetraacrylate, erythritol di-, tri- or tetraacrylate, acrylated polyester oligomer, bisphenol A diacrylate, acrylated bisphenol A diglycidylether, ethyoxylated bisphenol A diacrylate, and the like. Other suitable acrylate compounds include tris(2-hydroxyethyl) isocyanurate triacrylate and acrylated urethane oligomers.

Other suitable polyene compounds are compounds having two or more allylic groups. Examples of these include polyallyl ethers of a polyol and polyallyl esters of a polycarboxylic acid.

Suitable polyallyl ethers include, for example, 1,4-butanediol diallyl ether, 1,5-pentanediol diallyl ether, 1,6-hexanediol diallyl ether, neopentyl glycol diallyl ether, diethylene glycol diallyl ether, triethylene glycol diallyl ether, tetraethylene glycol diallyl ether, polyethylene glycol diallyl ether, dipropylene glycol diallyl ether, tripropylene glycol diallyl ether, cyclohexane dimethanol diallyl ether, alkoxylated hexanediol diallyl ether, neopentyl glycol diallyl ether, propoxylated neopentyl glycol diallyl ether, trimethylolpropane di- or triallyl ether, ethoxylated trimethylolpropane di- or triallyl ether, propoxylated trimethylolpropane di- or triallyl ether, glycerine di- or triallyl ether, ethyloxylated and/or propoxylated glycerine di- or triallyl ether, pentaerythritol di-, tri- or tetraallyl ether, erythritol di-, tri- or tetraallyl ether, acrylated polyester oligomer, bisphenol A diacrylate, acrylated bisphenol A diglycidylether, ethyoxylated bisphenol A diallyl ether, and the like.

Examples of suitable polyallyl esters include diallyl maleate, diallyl fumarate, diallyl phthalate, diallyl terephthalate, diallyl succinate, di- or triallyl citrate and the like.

Other useful polyene compounds include triallyl cyanurate and triallyl isocyanurate (TAIC).

The amount of polyene compound in the reactive mixture (prior to any reaction) may be, for example, 0.05 to 2 parts by weight per 100 parts by weight of polylactide resins, when performing branching while minimizing gel formation and/or crosslinking. In specific embodiments the reactive mixture may prior to reaction contain at least 0.075 part or at least 0.1 parts by weight of the polyene compound per 100 parts by weight of polylactide resins and up to 1 part, up to 0.5 part or up to 0.25 part, on the same basis.

The branched product may be chilled such as by immersing it in cool water or other fluid and then chopped to form pellets that are useful in a subsequent melt-processing operation. In an integrated branching/melt processing operation, the extruder or other apparatus used to perform the branching step may feed downstream melt-processing apparatus directly or indirectly, in some cases without solidifying the extruded material. These melt-processing operations may include, for example, extrusion foaming; melt coating; melt fiber spinning; injection molding; blow molding, injection stretch blow molding; thermoforming; film coextrusion; blown film manufacture, and the like. The compositions are particularly beneficial in applications in which high melt strength and/or high drawability are needed. These include melt coating, film and sheet extrusion, extrusion foaming and deep draw thermoforming.

In other embodiments, the branched product may be further let down into another polymer.

The branched polylactide may be characterized by any one or more of the following parameters:

A) An absolute weight average weight (M_{w}) greater than that of the additional linear polylactide resin(s). The absolute M_{w} of the branched polylactide resin may be, for example, at least 1.5 times, at least 1.8 times, at least 2 times, at least 2.5 times, at least 3 times or at least 3.5 times that of the additional linear polylactide resin(s). In some embodiments, it is up to 5 times that of the starting polylactide resin(s). All absolute molecular weights mentioned herein are measured by gel permeation chromatography/size exclusion chromatography using triple detection (light scattering, viscometer and refractive index detection). The absolute M_{w} may be at least 150,000, at least 200,000, at least 300,000, at least 350,000 or at least 400,000 g/mol.

B) A polydispersity (absolute M_{w}/absolute Mₙ) of at least 2.5. The polydispersity may be at least 2.7, at least 3.0, at least 3.3, at least 3.5, at least 3.8 or at least 4.0. In some embodiments the polydispersity is up to 6 or up to 5.

C) An absolute Z-average molecular weight (M_{z}) greater than that of the additional linear polylactide resin(s). The absolute M_{z} of the branched polylactide resin may be, for example, at least 3 times, at least 5 times, at least 10 times or at least 15 times that of the additional linear polylactide resin(s), and may be up to, for example, 30 times or up to 25 times that of the additional linear polylactide resin(s).

D) A branching number (Bₙ) of at least 2.5. The branching number may be at least 3.0, at least 3.5, at least 4, at least 5, at least 6 or at least 7 and may be, for example, up to 12, up to 10 or up to 8. Branching number is measured using a method as described in the examples of WO 2019/152264.

E) A gel content of 15% or less by weight, based on the weight of the polylactide composition, as measured by size exclusion chromatography. The gel content may be 10% or less, 8% or less or 6% or less. Gel content is conveniently measured by passing a weighed amount of the polylactide composition through a 0.2 μm filter and determining the amount of material (gels) captured by the filter.

The branched polylactide composition exhibits an increased melt strength compared to the unbranched starting resin, measured as described in the following examples. Increased melt strength, for purposes of this invention, is indicated by a decreased tan delta value relative to that of the unbranched polylactide, under conditions of 210° C. and an angular frequency rate of 0.8 radians/sec. The branched polylactide may, for example exhibit a tan delta value of up to 10, up to 7, up to 6, up to 5, up to 2.5 or up to 2 under those measurement conditions.

The branched polylactide composition exhibits an increased complex viscosity when measured as described in the following examples, under conditions of 210° C. and 0.1 radians/sec angular frequency. The complex viscosity may be at least 2,000, at least, 3,000, at least 5,000 at least 10,000 Pas, and up to, for example, 25,000 or up to 20,000 Pa·s.

The polylactide-peroxide masterbatch of the invention is also useful for producing crosslinked polylactides. In general, crosslinked polylactides are made in the same general manner described before with regard to producing branched polylactides, the main difference being in the amount of peroxide provided by the polylactide-peroxide masterbatch and, in preferred cases, the amount of optional polyene compound. Greater amounts of peroxide and/or greater amounts of polyene compound favor greater amounts of crosslinking. For example, to perform crosslinking, relative amounts of polylactide-peroxide masterbatch and additional linear polylactide resin may selected so the reactive mixture contains as much as 5 weight percent of the peroxide, such as 0.5 to 5 weight percent or 1 to 5 weight percent. The amount of polyene compound in the reactive mixture (prior to any reaction) may be, for example, 2 to 10 parts by weight per 100 parts by weight of polylactide resins when crosslinking is desired. Longer reaction times also favor more crosslinking. It is possible to obtain fully thermoset polylactide resins having at most 10% extractables (or even less) using the process of this invention.

The following examples are provided to illustrate the invention, but not to limit the scope thereof. All parts and percentages are by weight unless otherwise indicated.

The Cyclic Peroxide Solution is 40 weight-% solution of 3,6,9-triethyl-3,6,9-trimethyl-1,4,7-triperoxanone, which is available as Trigonox® 301 from Nouryon. Its half-life is 141 seconds at 180° C. and 12 seconds 210° C. The Cyclic Peroxide Solution is absorbed onto polylactide pellets at a concentration of 40% by weight of the Cyclic Peroxide Solution and 60% by weight of the polylactide. The concentration of active peroxide in the masterbatch is 16% by weight.

### EXAMPLE 1

100 parts linear amorphous grade polylactide (a random copolymer of about 90% meso-lactide and 10% L-lactide, about 55% L-lactic units and 45% D-lactic units) are combined with 5 parts of di-t-amyl peroxide (Luperox® DTA, available from Arkema USA) in a Brabender batch mixer at 100° C. and mixed for 15 minutes. At this temperature, the peroxide has a half-life of 210 hours and is stable. After the mixing is completed the resulting polylactide-peroxide masterbatch (Ex. 1) is cooled to room temperature. TGA analysis of the masterbatch reveals a weight loss in the range of 140-180° C., peaking at 165° C., which is attributed to the decomposition of the peroxide. TGA testing of the neat peroxide shows a peak weight loss at only 153° C. The decomposition of the peroxide is slowed by virtue of being formed into the polylactide-peroxide masterbatch.

A mixture of 100 parts a linear semi-crystalline grade polylactide (copolymer of L-lactide and meso-lactide, about 95.5% L-lactic units an 4.5% D-lactic units) and about 0.2 parts by weight of triallyl isocyanaurate is heat-softened in the Brabender mixer at 195° C. and 60 rpm stirring rate. Five parts of polylactide-peroxide masterbatch Example 1 (enough to provide a peroxide loading of 0.25%) are added to the mixer and heated at the same temperature with continued stirring for 7 minutes, which corresponds to about 6 half-lives of the peroxide at that temperature. The resulting branched polylactide (Branched Example 1A) is then cooled to room temperature.

Branched Example 1B is made the same way, reducing the amount of the polylactide-peroxide masterbatch to about 3.3 parts to provide a peroxide loading of 0.0167%). Branched Example 1C also is made the same way, reducing the amount of the polylactide-peroxide masterbatch to about 1.7 parts to provide a peroxide loading of 0.0083%).

For comparison, Branched Example 1C is reproduced, adding the peroxide as a neat liquid instead of being first formed into a masterbatch. This is indicated as Comparative Sample A. Attempts to increase the amount of peroxide as a neat liquid resulted in uncontrollable decomposition of the peroxide, raising safety concerns, and are 5 discontinued.

The complex viscosity and tan delta of each of Branched Examples 1A-1C and Comparative Sample A are evaluated. Test samples are dried overnight at 48° C. under vacuum, and are made on the dried samples using an ARES G2 rheometer with 25-mm parallel plate fixture and a 2-mm gap. Measurements are made at 210° C. at an angular frequency of 0.1 to 500 radians/second. Measured values are made at 0.1 rad/s (complex viscosity) and 0.8 radians/second (tan 8). Results are as indicated in Table 1.

TABLE 1

| | | Complex | |
|---|---|---|---|
| | Peroxide, | Viscosity, Pa · s, | Tan Delta, |
| Designation | Wt-% | 210° C., 0.1 rad/s | 210° C., 0.8 rad/s |
| 1A | 0.25% | 12,000 | 1.5 |
| 1B | 0.166% | 3,000 | 5 |
| 1C | 0.083% | 2,000 | 6 |
| A* | 0.083% | 1,600 | 17 |

*Comparative example.

The results for Branched Example 1C and Comparative Sample A show how branching efficiency is increased with the use of a polylactide-peroxide masterbatch of the invention. Although the peroxide levels are the same in each case, Branched Example 1C has a higher complex viscosity at 0.1 rad/s shear rate and lower tan delta at 0.8 rad/s. Lower tan delta values indicate better melt strength. Higher viscosity and higher melt strength each are indicative of more efficient branching.

Examples 1A and 1B illustrate a further important advantage of the invention, the ability to incorporate higher levels of peroxide into the branching reaction while continuing to operate under controlled conditions. Much higher viscosities and lower tan delta values are obtainable in this way.

### EXAMPLE 2

A polylactide-peroxide masterbatch is made in the same general manner as described in Example 1, replacing the di-t-amyl peroxide with 10 parts of a 40% solution of 3,6,9-triethyl-3,6,9-trimethyl-1,4,7-triperoxonane (Trigonox® 301 from Nouryon). The resulting masterbatch (Example 2) contains 4% active peroxide. Masterbatch Example 2 is evaluated by TGA as described for Example 1, as is a commercial product having 40% of Trigonox 301 infused into 60% of a porous polylactide product (Nouryon Trigonox 301-40PLA MB, as described in U.S. Pat. No. 9,527,967). The Trigonox 301-40PLA MB product loses 5% of its weight in the temperature range 70-97° C. and 30% of its weight after being heated to 140-150° C. Masterbatch Example 2 shows weight loss commencing at 146° C. and continuing to 214° C. The polylactide-peroxide masterbatch again appear to stabilize the peroxide.

Branching reactions are performed using Masterbatch Example 2 in the same general manner as described in Example 1. The additional polylactide resin in this case is a linear amorphous grade, being a copolymer of L-lactide and meso-lactide having about 88% L-lactic units and 12% D-lactic units. Proportions of additional polylactide resin and Masterbatch Example 2 are selected to provide active peroxide loadings of 0.065% (Branched Example 2A) and 0.1% (Branched Example 2B). Complex viscosity and tan delta are measured as before with results as indicated in Table 2.

TABLE 2

| | | Complex | |
|---|---|---|---|
| | Peroxide, | Viscosity, Pa · s, | Tan Delta, |
| Designation | Wt-% | 210° C., 0.1 rad/s | 210° C., 0.8 rad/s |
| 2A | 0.065% | 6,500 | 2.5 |
| 2B | 0.1% | 15,000 | 1 |

### EXAMPLES 3-5

Polylactide-peroxide masterbatch Examples 3-5 are made in the Brabender mixer using the linear amorphous grade polylactide resins indicated in Table 3. 90 parts of the resin are heated to the set temperature indicated in Table 3 with 60 rpm stirring, and 10 parts of Trigonox® 301 are added, to produce a masterbatch containing 4% active peroxide. Mixing is continued for 15 minutes. In each case, a drop in torque is experienced after several minutes mixing due to the plasticization effect of the solvent in the Trigonox® 301 product, indicating that the peroxide has become dissolved or uniformly dispersed into the polylactide resin. The temperature of the melt is measured, with the peak recorded temperature as indicated in Table 3. As seen in Table 3, the peak temperature is slightly higher than the set temperature due to shear heating.

TABLE 3

| | Polylactide Resin | | | Set | Peak |
|---|---|---|---|---|---|
| | % L-Lactic | % D-Lactic | | Temp., | Temp., |
| Ex. No. | Units | Units | M_{w}¹ | ° C. | ° C. |
| 3 | 80 | 20 | 61,000 | 100 | 106.2 |
| 4 | 88.7 | 11.3 | 191,000 | 150 | 165.1 |
| 5 | 88.3 | 11.7 | 111,000 | 140 | 152.7 |

¹Weight average molecular weight by GPC relative to polystyrene standards.

Polylactide-peroxide Masterbatch Examples 3-5 are used to branch a linear semi-crystalline grade polylactide (copolymer of L-lactide and meso-lactide, about 95.5% L-lactic units an 4.5% D-lactic units) in the presence of 0.2% TAIC (active basis), in the same general manner described in Example 1. The weight ratios of the semi-crystalline grade polylactide and masterbatch are 100:0.3, to supply 0.012 weight-% of active peroxide into the reactive mixture.

Complex viscosity and tan delta of the branched products are measured as before with results as indicated in Table 4, where the branched samples are designated 3A, 4A and 5A, respectively. Absolute molecular weight, polydispersity (M_{w}/Mₙ) and branching number are evaluated by gel permeation chromatography using a Viscotek GPCmax VE2001 GPC/SEC system (Malvern) equipped with a Viscotek TDA 302 triple detector array module (light scattering, viscometer, refractive index detectors). The mobile phase is THF (refractive index 1.405) at a rate of 1.0 mL/min and a temperature of 30° C. RI dn/dc is 0.185 for polystyrene standards and 0.046 for polylactide samples. Absolute Mₙ, absolute M_{w}, polydispersity, absolute M_{z}, intrinsic viscosity, branching number, and Mark-Houwink slope are all determined using OmniSEC version 4.7 software. Branching calculations are made using the “star” architecture option. “MH exponent” is inputted as 0.68, “MH intercept” is inputted as −3.39, “structure factor” is inputted as 0.75 and “repeat factor” is inputted as 72,000. Results are as indicated in Table 4. Values for the linear semi-crystalline grade polylactide are provided for comparison.

TABLE 4

| | | Complex | | | | |
|---|---|---|---|---|---|---|
| | | Viscosity, | Tan Delta, | | | |
| | Peroxide, | Pa · s, 210° C., | 210°, 0.8 | Absolute | | Branching |
| Designation | Wt-% | 0.1 rad/s | rad/s | M_{w} | M_{w}/Mₙ | Number |
| 3A | 0.012% | 1,100 | 10 | 154,000 | 2.82 | 3.62 |
| 4A | 0.012% | 1500 | 9 | 141,000 | 2.62 | 3.26 |
| 5A | 0.012% | 900 | 14 | 121,000 | 2.32 | 2.77 |
| Unbranched | 0 | 500 | >50 | 91,000 | 1.80 | 2.00 |
| polylactide* | | | | | | |

*Comparative

As the results in Table 4 show, significant branching is obtained with the invention even at very low peroxide levels. Melt strength increases substantially.

1. A solidified polylactide-peroxide masterbatch comprising a thermoplastic resin phase comprising at least 50% by weight of a linear amorphous grade polylactide resin based on the weight of the thermoplastic resin phase and 1 to 30 parts by weight per 100 parts by weight of the thermoplastic resin phase of a peroxide, the peroxide having a half-life of at least 50 seconds at 180° C. dissolved or dispersed in the thermoplastic resin phase.

2. The solidified polylactide-peroxide masterbatch of claim 1 which is non-porous.

3. The solidified polylactide-peroxide masterbatch of claim 1 wherein the linear amorphous grade polylactide resin contains 40 to 60 weight percent L-lactic units and correspondingly 60 to 40 weight percent D-lactic units, based on the weight of the lactic units of the solidified linear amorphous grade polylactide resin.

4. The solidified polylactide-peroxide masterbatch of claim 3 wherein the linear amorphous grade polylactide resin contains 20 to 80 weight percent L-lactic units and correspondingly 80 to 20 weight percent D-lactic units, based on the weight of the lactic units of the solidified linear amorphous grade polylactide resin.

5. The solidified polylactide-peroxide masterbatch of claim 1 wherein the linear amorphous grade polylactide resin contains greater than 80% and at most 90% L-lactic units and correspondingly less than 20% and at least 10% D-lactic units or greater than 80% and at most 90% D-lactic units and correspondingly less than 20% and at least 10% L-lactic units, based on the weight of lactic units in the random copolymer.

6. The solidified polylactide-peroxide masterbatch of claim 1 wherein the peroxide is a cyclic peroxide having any of the structures I-III: 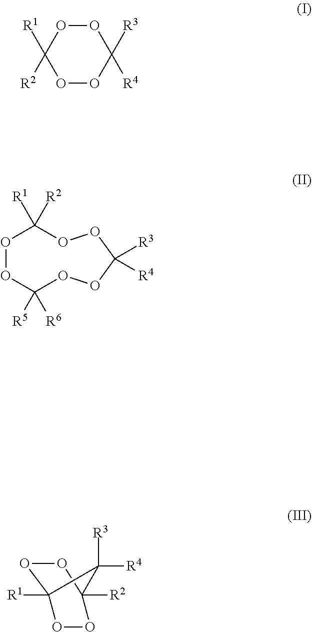
wherein each of R¹-R⁶ are independently selected from the group consisting of hydrogen, C₁₋₂₀ alkyl, C₃₋₂₀ cycloalkyl, C₆₋₂₀ aryl, C₇₋₂₀ aralkyl and C₇₋₂₀ alkaryl, any of which may optionally be substituted with one or more groups selected from hydroxyl, alkoxy, linear or branched alkyl, aryloxy, ester, carboxy, nitrile and amido.

7. The solidified polylactide-peroxide masterbatch of claim 1 wherein the peroxide is a cyclic peroxide having the structure: 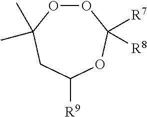
wherein R⁷, R⁸ and R⁹ are independently hydrogen or hydrocarbyl that may be substituted with one or more groups selected from hydroxyl, alkoxy, linear or branched alkyl, aryloxy, ester, carboxy, nitrile and amido and provided that any two of R⁷, R⁸ and R⁹ may together form a divalent moiety that forms a ring structure with the intervening atoms of the trioxepane ring.

8. The solidified polylactide-peroxide masterbatch of claim 1 wherein the peroxide includes one or more of di-t-amyl peroxide, 3,6,9-triethyl-3,6,9-trimethyl-1,4,7-triperoxanone, 3,3,5,7,7-pentamethyl-1,2,4-trioxepane and 3-ethyl-3,5,7,7-tetramethyl-1,2,4-trioxepane.

9. A method for making a solidified polylactide-peroxide masterbatch, comprising the steps of
i) combining a) one or more thermoplastic resins, the thermoplastic resins comprising at least 50% by weight of a starting linear amorphous grade polylactide resin with b) 1 to 30 parts by weight, per 100 parts by weight of the starting amorphous grade PL(Original) A resin, of a peroxide, the peroxide having a half-life of at least 50 seconds at 180° C. and mixing the starting linear amorphous grade polylactide and the peroxide at a temperature of 80 to 170° C. to produce a solution or dispersion of the one or more peroxides in the thermoplastic resins, and
ii) cooling the solution or dispersion to a temperature of at most 40° C. to produce the solidified polylactide-peroxide masterbatch.

10. The method of claim 9 where step i) is performed in the absence of a blowing agent to produce a non-porous polylactide-peroxide masterbatch.

11. The method of claim 9 wherein the temperature is 80 to 160° C.

12. The method of claim 9 wherein the starting linear amorphous grade polylactide resin contains 20 to 80 weight percent L-lactic units and correspondingly 80 to 20 weight percent D-lactic units, based on the weight of the lactic units of the starting linear amorphous grade polylactide resin and the temperature is 80 to 130° C.

13. The method of claim 9 wherein the peroxide is a cyclic peroxide having any of the structures I-III: 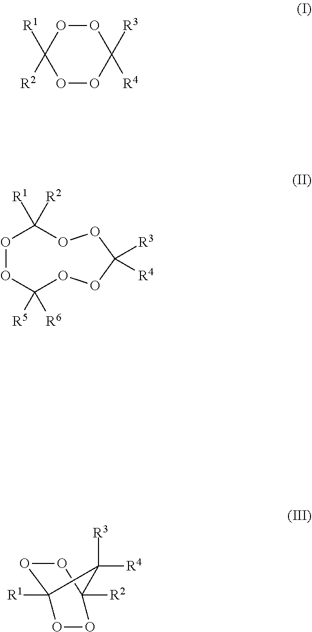
wherein each of R¹-R⁶ are independently selected from the group consisting of hydrogen, C₁₋₂₀ alkyl, C₃₋₂₀ cycloalkyl, C₆₋₂₀ aryl, C₇₋₂₀ aralkyl and C₇₋₂₀ alkaryl, any of which may optionally be substituted with one or more groups selected from hydroxyl, alkoxy, linear or branched alkyl, aryloxy, ester, carboxy, nitrile and amido.

14. The method of any of claim 9 wherein the peroxide is a cyclic peroxide having the structure: 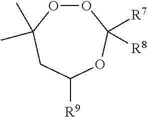
wherein R⁷, R⁸ and R⁹ are independently hydrogen or hydrocarbyl that may be substituted with one or more groups selected from hydroxyl, alkoxy, linear or branched alkyl, aryloxy, ester, carboxy, nitrile and amido and provided that any two of R⁷, R⁸ and R⁹ may together form a divalent moiety that forms a ring structure with the intervening atoms of the trioxepane ring.

15. The method of claim 9 wherein the peroxide includes one or more of di-t-amyl peroxide, 3,6,9-triethyl-3,6,9-trimethyl-1,4, 7-triperoxanone, 3,3,5, 7,7-pentamethyl-1,2,4-trioxepane and 3-ethyl-3,5,7,7-tetramethyl-1,2,4-trioxepane.

16. A method for branching and/or crosslinking polylactide, comprising the steps of
I. combining the solidified polylactide-peroxide masterbatch of claim 1 with additional linear polylactide resin to produce a reactive mixture containing 0.01 to 0.5 weight percent of the peroxide and polylactides comprising the starting linear amorphous grade polylactide resin and the additional linear polylactide resin; and
II. heating the reactive mixture obtained in step I to a temperature of at least 180° C. to heat-soften the polylactides, decompose the peroxide and branch and/or crosslink at least a portion of the polylactides.

17. The method of claim 16 wherein step II is performed in the presence of 0.05 to 1.5 weight percent, based on the weight of the polylactides, of at least one polyene compound having 2 to 6 vinyl groups and an equivalent weight per vinyl group of up to 500.

18. The method of claim 16 wherein the additional linear polylactide resin is an amorphous grade.

19. The method of claim 16 wherein the additional linear polylactide resin is a semi-crystalline grade.
